(19) United States
(12) Patent Application Publication
(10) Pub. No.: US 2003/0126435 A1
(43) Pub. Date: Jul. 3, 2003

(54) Method, mobile telecommunication network, and node for authenticating an originator of a data transfer

(76) Inventors: Jerry L. Mizell, Plano, TX (US); David J. Lauson, McKinney, TX (US); Margaret Kaczmarska, Plano, TX (US)

Correspondence Address: MUNSCH, HARDT, KOPF & HARR, P.C., INTELLECTUAL PROPERTY DOCKET CLERK, 1445 ROSS AVENUE, SUITE 4000, DALLAS, TX, 75202-2790, US

(21) Appl. No.: 10/035,653

(22) Filed: Dec. 28, 2001

(51) Int. Cl. H04L 9/00

(52) U.S. Cl. 713/168; 380/277

(57) ABSTRACT

A method of authenticating an originator of a packet in a network comprising filtering the packet for a tag embedded therein, reading the tag contents including an identifier and an encrypted hash, decrypting the encrypted hash included in the tag, calculating a second hash from the identifier of the originator, and authenticating the originator of the packet upon determining the decrypted hash and the calculated hash are identical is provided. A node for authenticating an originator of a packet comprising a processing unit, a memory unit operable to store an authentication algorithm therein, and an interface to a network medium operable to receive the packet, the authentication algorithm operable to filter the packet for a tag embedded therein, decrypt an encrypted hash in the embedded tag, calculate a hash from an identifier in the tag, and authenticate the originator upon a comparison between the decrypted hash and the calculated hash is provided.

### TECHNICAL FIELD OF THE INVENTION

This invention relates to mobile telecommunication systems and, more particularly, to a system, method and network for authenticating an originator of a data transfer.

### BACKGROUND OF THE INVENTION

The evolution of mobile telecommunication systems has brought about numerous offerings in the form of subscriber services. Early telecommunication systems, for example the advanced mobile phone system, were analog cellular systems and, consequently, were limited to providing basic voice services. However, modern telecommunication systems provide digital communications and are no longer confined to strictly voice services. Various data services are currently offered to cellular subscribers and include text messaging, and email as well as cellular Internet services presently being deployed. For example, general packet radio services (GPRS) were introduced in the Global System for Mobile communications (GSM) to more effectively utilize the radio spectrum for providing data oriented services. GPRS is a packet switched, rather than a circuit switched, data service and generally is more efficient than circuit switched data services because of deallocations of radio resources made during idle periods in a data communication session.

Various control nodes are typically distributed throughout the mobile telecommunication system. For example, mobile service switching centers (MSCs) are responsible for performing control and supervisory functions related to mobile connections to circuit switched networks, for example the public switched telephone network (PSTN). A gateway GPRS support node (GGSN) is typically accessed for connecting to a packet data network to access general packet radio services such as wireless Internet services. One or more Serving GPRS Support Nodes (SGSN) are included within the mobile telecommunication system for providing the mobile terminal access to the GPRS services, for example administering packet data protocol (PDP) sessions as well as performing managerial functions such as mobile terminal authentication, identification and international mobile subscriber identity (IMSI) interrogations. Thus, the GGSN provides an interface for the mobile telecommunications system to the data network while the SGSNs enable the mobile terminal to communicate with the GGSN and thus the packet data network over legacy mobile telecommunication system infrastructures.

Voice and data mobile telecommunication services are provided over an air interface between the mobile terminal and the mobile telecommunication system. One or more base transceiver stations (BTSs) engage an active mobile terminal over an air interface. The BTSs are controlled and supervised by base station controllers (BSCs). The BSCs are, in turn, managed by MSCs. Each BSC can control multiple BTSs. Similarly, each MSC can manage multiple BSCs. Each BSC and the BTSs controlled thereby comprise a base station subsystem (BSS). The MSC and associated managerial hardware and software comprise a switching subsystem (SS).

Mobile terminal voice service subscriptions typically levy a fee for a given quantity of network access time. Additional tariffs may then be implemented when the subscriber exceeds the allotted access time. Often, the network operators assign a home area within the mobile telecommunications network in which the access time may be used. When a subscriber travels outside the home area, additional tariffs may be levied, typically in the form of higher tariffs per unit of access time.

Network operators are finding a growing demand for data services such as GPRS. Various usage-based tariff schemes have been implemented for applying toll charges based on the volume of data usage by a mobile terminal. Much like common cellular voice subscription services that charge a flat fee for a particular number of minutes of cellular access, data usage tariffs commonly have fee structures based on the amount of data transmitted to or from the mobile terminal. A mobility call detail record (M-CDR) may be activated whenever a mobile terminal attaches to a mobile telecommunication system (MTS). Containers within the M-CDR monitor the location of the mobile terminal within the network. The M-CDR is typically maintained as long as the mobile terminal is attached to the MTS and remains in a specific coverage area of the network, for example a location area that is limited to the geographic service area of a single SGSN.

A Serving GPRS Support Node call detail record (S-CDR) may be utilized for monitoring the traffic volume to and from a mobile terminal. A S-CDR is opened in an SGSN whenever an attached mobile terminal initiates a data session, for example a packet data protocol session. In an active session, the mobile terminal is able to transfer and receive payload data on a respective uplink and downlink with a packet data network, whereas when the mobile terminal is only attached, the mobile terminal is in a state designated as ‘stand-by’. The S-CDR creates a traffic volume container that monitors the volume of data transfers made from the mobile terminal to the data network on the uplink and the volume of data transfers made to the mobile terminal on the downlink. When the mobile deactivates, or when the mobile terminal roams into a cell having data services provided by another SGSN, the S-CDR is closed. The S-CDR can then be retrieved from the SGSN by a charging gateway function (CGF), or another accounting node of the network, and processed to levy appropriate fees to the subscriber of the mobile terminal. Call detail records may be implemented in the GGSN that combine functionality of both an M-CDR and an S-CDR.

Network operators have devised various ‘triggers’ for enabling variations in the tariffs associated with data transfers to a mobile terminal. Tariff time change triggers can be executed in an SGSN for enabling variations in the billing fees associated with mobile data services according to, for example, the time of day or the day of week that the data transfers are made. A tariff time change trigger is typically invoked by a system clock in the SGSN and, upon execution thereof, causes any open traffic volume containers in an S-CDR to be closed. A new traffic volume container is opened within the S-CDR and the traffic volume is then monitored and counted in the newly opened traffic volume container. The traffic volume containers generally include timestamps, along with other information, for facilitating proper billing when the S-CDR is processed by the operator's billing system.

Partial record triggers may also be implemented to guard against loss of data, for example a failure in a SGSN that causes a loss of S-CDRs or M-CDRs, that would adversely effect the network operator's ability to implement an accurate billing to the mobile subscriber's effected by lost S-CDRs or M-CDRs. A partial record S-CDR is created by clearing, or zeroing, the contents of the traffic volume containers in an open S-CDR after reporting these contents to an appropriate management node, for example a CGF. Accumulation of further traffic volume counts are then made from the zeroed traffic volume container in the S-CDR. To facilitate accurate billing to a subscriber having traffic volume counts accumulated over multiple partial records, a record sequence number may be stored in a field of the S-CDR. Each time a partial record is made, the record sequence number in the S-CDR is incremented. The CGF, or similar facility, can later combine the partial records according to the record sequence numbers for providing an appropriate billing to the subscriber associated therewith. Common S-CDR partial record triggers include duration triggers, traffic volume triggers, and triggers based on the number of traffic volume containers in an S-CDR. Other S-CDR partial record triggers may be implemented by management intervention. Similar M-CDR partial record triggers may be likewise implemented.

Different mobile subscribers may have different preferences with regard to the quality of service provisioned by the SGSN when accessing a data network. Quality of Service (QoS) triggers have been implemented to allow variations in billing fees associated with the quality of service a mobile terminal is provided with when accessing a data network. For example, the network operator may impose a higher tariff when a mobile terminal accesses a data network on full-rate equipment rather than half-rate equipment. A QoS trigger facilitates quality of service tariff changes during an active session with a data network by closing an open traffic volume container in a S-CDR when a QoS criteria threshold is met during the data session. For example, during an active session, full-rate channels in a BTS serving the mobile terminal may become unavailable. When a mobile terminal switches to a full-rate channel from a half-rate channel, a QoS trigger may close a current traffic volume container and open another traffic volume container. The network operator then may impose a higher tariff when a user accesses a data network over a full-rate channel.

Standards have been devised for implementation of differentiated classes of service, or differentiated services (DS), for providing quality of service in IP networks. Differentiated services allow control of network traffic such that certain types of traffic have a greater precedence assigned thereto and, accordingly, may receive preferential allocation of network resources when in transit across a network. Assignment of precedence to network traffic via implementation of differentiated services allows network traffic to be managed according to class of service specifications that define best-effort traffic control treatments. Differentiated services employ network policies, i.e. sets of statements that define how network resources are to be allocated among various network clients, for evaluating how a network packet is to be treated at a differentiated service compliant node of a network. Particularly, packets routed according to differentiated services specifications have per hop behaviors (PHBs) assigned thereto, for example a PHB specified by the type-of-service (TOS) field of an IPv4 packet header, a PHB specified by traffic class field of an IPv6 packet header, or by another designation in a packet that specifies a particular PHB.

Heretofore, however, a mobile network operator has not had the ability to impose variations in tariffs assigned to data transfers made in a mobile network according to differentiated services specifications or to assign a tariff to data transfers originated from a particular network entity. As GPRS services become more widely available and with mobile networks becoming more ubiquitous with the Internet, differentiated services deployed on mobile networks will require accounting mechanisms able to distinguish between data delivered at various classes of service. Therefore, it may be seen from the foregoing that a technique for authenticating an originator of a data transfer and levying a tariff against the originator is desired.

### SUMMARY OF THE INVENTION

In accordance with an embodiment of the present invention, a method of authenticating an originator of a packet in a network comprising filtering the packet for a tag embedded therein, reading the tag contents including an identifier and an encrypted hash, decrypting the encrypted hash included in the tag, calculating a second hash from the identifier of the originator, and authenticating the originator of the packet upon determining the decrypted hash and the calculated hash are identical is provided.

In accordance with another embodiment of the present invention, a node in a network for authenticating an originator of a packet comprising a processing unit, a memory unit operable to store an authentication algorithm therein that is executable by the processing unit, and an interface to a network medium operable to receive the packet, the authentication algorithm operable to filter the packet for a tag embedded therein, decrypt an encrypted hash in the embedded tag, calculate a hash from an identifier in the tag, and authenticate the originator upon a comparison between the decrypted hash and the calculated hash is provided.

In accordance with another embodiment of the present invention, a telecommunication network operable to transmit a data packet from an originator to a terminating device within the network comprising a first node connected to a data network and operable to receive the packet generated by the originator, the first node operable to execute an authentication algorithm operable to filter the packet for a tag embedded therein, decrypt an encrypted hash in the embedded tag, calculate a hash from an identifier in the tag, and authenticate the originator upon a comparison between the decrypted hash and the calculated hash, and a second node operable to receive the packet from the first node and transmit the packet to a terminating device is provided.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 is a block diagram of mobile telecommunications network on which the present invention may be implemented for providing multi-rate billing on a per-differentiated services basis;

FIG. 2 is a block diagram of an exemplary mobile telecommunication network including location areas and routing areas on which the present invention may be implemented;

FIG. 3 is a block diagram of a network node that may be implemented as a gateway general packet radio services node, an access router, or another network node according to an embodiment of the invention;

FIG. 4 illustrates a G-CDR that provides distinct traffic volume accounting on a per-differentiated service basis according to an embodiment of the invention;

FIG. 5 is a simplified illustration of a file that may be utilized by a mobile telecommunication system to provide transaction billing on a per-provider basis according to an embodiment of the invention;

FIG. 6 is a flowchart of an originator authentication technique according to an embodiment of the present invention; and

FIG. 7 is a flowchart of a process for provisioning per-originator multi-rate billing according to an embodiment of the present invention.

### DETAILED DESCRIPTION OF THE DRAWINGS

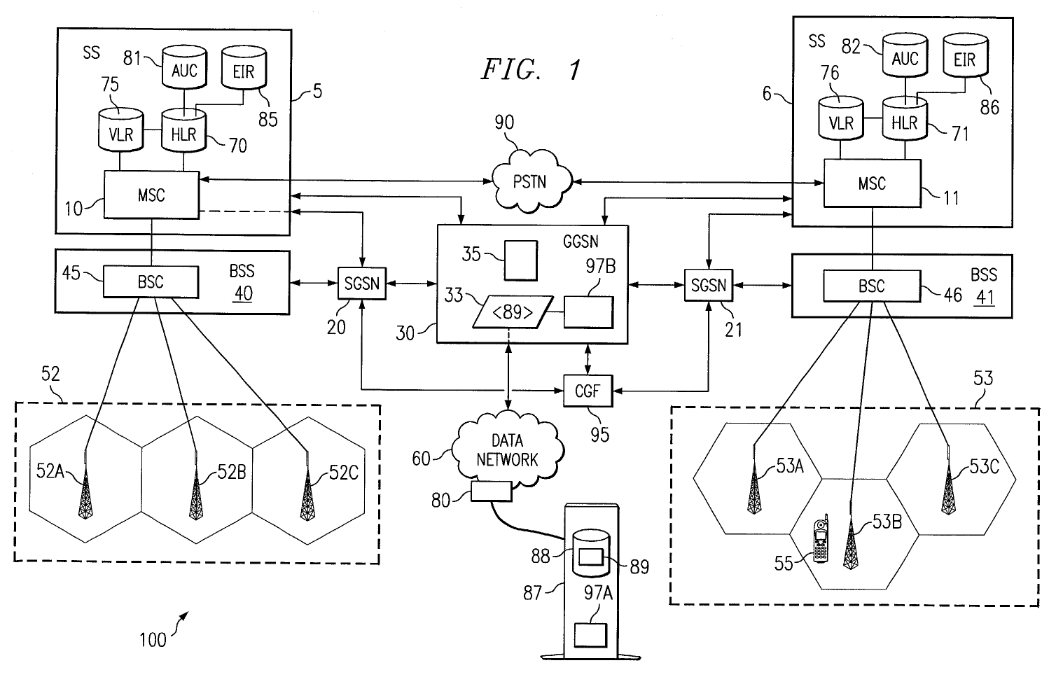

The preferred embodiment of the present invention and its advantages are best understood by referring to FIGS. 1 through 7 of the drawings, like numerals being used for like and corresponding parts of the various drawings.

In FIG. 1, there is illustrated a mobile telecommunications system (MTS) 100 in which the present invention may be implemented. The exemplary mobile telecommunication system 100 is described according to the general infrastructure and nomenclature of the Global System for Mobile communications (GSM) standards and General Packet Radio Services (GPRS) although the present invention is not limited to application in such a system. Cellular telecommunication services are provided to one or more mobile terminals (MTs) 55. The MTS 100 generally includes one or more switching systems (SSs) 5-6 and base station subsystems (BSSs) 40-41. The mobile terminal 55 can take on various forms other than a traditional cellular telephone, for example mobile terminal 55 may be a laptop computer with a wireless modem capable of mobile terminations, a wireless personal digital assistant, etc. Mobile terminal 55 communicates directly with one or more base transceiver stations (BTSs) 52A-52C and 53A-53C that operate under coordination of a base station controller (BSC) 45-46 and that collectively therewith comprise a respective base station subsystem BSS 40-41. Each BSS, for example BSS 40, will typically include one or more geographically diverse BTSs, for example BTSs 52A-52C. A group of BTSs, for example one of a BTS group 52-53, is managed by a base station controller (BSC) 45-46, also referred to as a radio network controller, that, in turn, communicates with, and is controlled by, a respective mobile services switching center (MSC) 10-11 included within a switching system (SS) 5-6. Each individual BTS 52A-52C and 53A-53C defines a radio cell operating on a set of radio channels thereby providing service to one or more mobile terminals (MTs) 55. Accordingly, each BSC 45-46 will have a number of cells corresponding to the respective number of BTSs 52A-52C and 53A-53C controlled thereby.

The switching system 5-6 contains a number of functional units implemented in various hardware and software. Generally, each SS 5-6 respectively contains an MSC 10-11, a Visitor Location Register (VLR) 75-76, a Home Location Register (HLR) 70-71, an Authentication Center 81-82, and an Equipment Identity Register 85-86. Mobile terminal 55 operable within the MTS 100 has a register designated as a home register. In the present illustration, and in the examples provided hereinbelow, HLR 71 represents the home register of the mobile terminal 55. HLR 71 is a database containing profiles of mobile terminals having the HLR 71 designated as the home register. The information contained within the subscriber profile in HLR 71 includes various subscriber information, for example authentication parameters such as an international mobile subscriber identity that may be compared with the IMSI stored in a subscriber identity module (SIM) of MT 55 for authentication purposes, an electronic serial number (ESN) and an authentication capability parameter as well as subscription service parameters such as an access point name (APN) that defines the services included in the subscription. Additionally, a subscriber profile of MT 55 in HLR 71 contains data related to the current, or last known, location of MT 55 within MTS 100, for example a location area identifier. The location data contained within HLR 71 associated with MT 55 is dynamic in nature, that is it changes as MT 55 moves throughout MTS 100. It should be understood that each MSC 10-11 may, and typically does, control more than one BSC 45-46. In FIG. 1, only one respective BSC 45-46 is shown controlled by MSC 10-11 to simplify discussion of the invention.

VLR 75-76 is a database that contains information about all MTs 55 currently being serviced by MSC 10-11 associated therewith. For example, VLR 76 will include information relating to each MT being serviced by MSC 11 and thus includes information associated with all MTs currently serviced by BTSs 53A-53C that are controlled by the associated BSC 46. When MT 55 enters a cell coverage area of a BTS controlled by another MSC, for example when MT 55 roams into the coverage area provided by BTS 52C, VLR 75 of SS 5 associated with BTS 52C will interrogate HLR 71 for subscriber information relating to MT 55. This information is then transferred to VLR 75. At the same time, VLR 75 transmits location information to HLR 71 indicating the new position of MT 55. The HLR profile associated with MT 55 is then updated to properly indicate the position of MT 55. This location information is generally limited to a location area identifier. The information transmitted to VLR 75 associated with a roaming MT 55 generally allows for call setups and processing for MT 55 without further interrogation of HLR 71, authentication and subscription service parameters of MT 55. Thus, when MT 55 attempts to perform or receive a call, for example a data call, SS 5 has the requisite information for performing the setup and switching functions to properly service MT 55. Additionally, VLR 75 will typically include more precise location information on MT 55 than HLR 71, for example VLR 75 may contain a BSC identifier indicating the particular BSC servicing MT 55. VLRs 75-76 may assign a temporary mobile subscriber identifier (TMSI) to MT 55 that is relevant only in the area serviced by the SS maintaining that particular VLR. When MT 55 leaves a visited service area of an MSC, the VLR information on MT 55 therein may be destroyed.

Each SS 5-6 may also include an authentication center (AUC) 81-82 connected to HLR 70-71 of the respective SS 5-6. AUC 81-82 provides authentication parameters to HLR 70-71 for authenticating MT 55-56. AUC 81-82 may also generate ciphering keys used for securing communications with MT 55. Additionally, each SS 5-6 may also include an equipment identity register (EIR) 85-86 database that contains the international mobile station equipment identity used to uniquely identify MT 55. EIR 85-86 is used to validate MT 55 requesting service in MTS 100.

General packet radio services (GPRS) may be provided in MTS 100 by including GPRS support nodes within MTS 100. GPRS support nodes include one or more gateway GPRS support (GGSN) nodes 30 and one or more servicing GPRS support (SGSN) nodes 20-21. SGSN 20-21 administers packet data protocol (PDP) sessions with MT 55 and is responsible for packet routing and delivery of data packets to and from MT 55 within a service area of MTS 100 assigned thereto. Additionally, SGSNs 20-21 are responsible for performing various mobility and managerial functions, MT 55 attach and detach procedures, MT 55 authentication, link management and other functions. SGSNs 20-21 respectively maintain a location register for facilitating execution of the various SGSN procedures. An SGSN location register maintains various location information, such as the current cell provided by BTS 52A-52C and 53A-53C in which MT 55 is located, identification of the current VLR 75-76 established for MT 55, and user profile information such as IMSI and packet data network addresses assigned to MT 55. An SGSN location register maintains location information for each MT 55 serviced thereby.

A gateway GPRS support node (GGSN) 30 is typically included in MTS 100 for connecting to a packet data network 60 to access general packet radio services such as wireless Internet services. GGSN 30 provides an interface between mobile telecommunications system 100 and packet data network 60, such as the Internet. Accordingly, GGSN 30 converts packets received by SGSN 20-21 connected thereto from the format utilized by MTS 100 data service, e.g. GPRS, to an appropriate PDP utilized by external data network 60, e.g. IP, X.25, etc, prior to transmitting data received from MT 55 to data network 60. Likewise, GGSN 30 converts data received from data network 60 addressed to MT 55 from the PDP utilized by data network 60 to the data protocol supported by MTS 100. Additionally, GGSN converts addresses of data received by data network 60 destined for MT 55 from the address format of data network 60, e.g. from an IP address, to an appropriate address for MTS 100, e.g. a GSM address. The readdressed and reformatted data packet(s) are then forwarded by GGSN 30 to SGSN 21 currently servicing MT 55. GGSN 30 may also perform various managerial functions such as authentication and charging functions.

A GPRS-capable MT 55 must first perform an attach procedure prior to accessing a packet data network. In general terms, the attach procedure is initiated by transmission of an Attach Request message to SGSN 21 servicing MT 55. In the present illustrative example, MT 55 is currently located within a cell provided by BSS 41. SGSN 21 is connected to BSS 41 by a communication channel and thus is responsible for providing GPRS services to MT 55. SGSN 21 then identifies and authenticates MT 55 after which an Update Location message is transmitted to HLR 71. Authentication of MT 55 may include interrogation by SGSN 21 of various modules in SS 6 maintaining HLR 71 assigned to MT 55, for example SGSN 21 may interrogate AUC 82 and/or EIR 86. Upon successful authentication of MT 55 by SGSN 21, the subscriber profile (or a portion thereof) maintained in HLR 71 is copied to SGSN 21 and assigns a packet temporary mobile subscriber identify (P-TMSI) is assigned to MT 55. A location update may be provided to HLR 71 by SGSN 21 and an acknowledgment of the location update may then be transmitted to SGSN 21 by HLR 71 as well.

To engage in packet communications, an attached MT 55 must perform an activation procedure to obtain an address used by data network 60, e.g. an IP address. For each data session established between MT 55 and data network 60, a record describing the session, such as PDP type, e.g. IPv4, IPv6, etc., the PDP address assigned to MT 55, a requested quality of service, the address of GGSN 30 providing the interface between MTS 100 and data network 60 for MT 55, and/or other information, is made and is commonly referred to as a context. Modern mobile devices may maintain multiple simultaneous contexts and each context may be stored in MT 55, SGSN 21, and GGSN 30.

With reference now to FIG. 2, there is illustrated a flow diagram of a PDP context activation. Generally, an Activation Request (Activate PDP Req) 200 message is transmitted from MT 55 to the currently servicing SGSN 21. SGSN 21 then sends a request for a PDP creation (PDP Create Req 210) to GGSN 30. GGSN 30 maintains a PDP context table and records the address of SGSN 21 servicing MT 55 so that packet data from data network 60 can be appropriately routed to MT 55 via SGSN 21. GGSN 30 replies to SGSN 21 with a PDP context creation confirmation message (PDP create 220) and SGSN 21 updates a PDP context table maintained thereby upon reception of the PDP context creation message. The PDP context creation confirmation may include the PDP address (in the event dynamic addresses are provided by GGSN 30). MT 55 is then informed of the created PDP context by a confirmation message (Activate PDP Accept 230) transmitted thereto by SGSN 21. GGSN 30 will then update the SGSN address recorded in the PDP context table stored thereby whenever MT 55 roams into a cell provided by a BTS serviced by another SGSN, for example when MT 55 roams into the cell provided by BTS 52C serviced by SGSN 20. MT 55 may then engage in an IP session 250 with an entity of network 60 via SGSN 21 and GGSN 30. A billing node, for example a charging gateway function 95, may be included for receiving usage statistics, for example usage data in the form of M-CDRs, S-CDRs, and/or gateway GPRS support node-call detail records (G-CDRs) on individual mobile subscribers to facilitate appropriate billing thereof as described more fully hereinbelow.

The present invention provides a technique for providing multi-rate billing dependent upon differentiated service classifications. Differentiated services may be indicated by a bit pattern in each packet delivered, such as a designated bit pattern in the traffic class octet of an IPv6 header. Per hop behaviors are specified by the traffic class octet and the packet is treated accordingly in transit across the subscriber's carrier network. A carrier edge device, such as an access router at a border of the subscriber's carrier network, is preferably responsible for denoting the differentiated service requested by the subscriber by, for example, marking the traffic class octet of an IPv6 header received from data network 60 prior to forwarding the packet across MTS 100 to MT 55. MTS 100 will then transfer the packet according to per hop behaviors consistent with the requested class of service. The packet is then delivered to GGSN 30 servicing MT 55, the PDP address is resolved to an appropriate address for routing across MTS 100 thereby, and GGSN forwards the packet to SGSN 21 servicing MT 55 where it is forwarded to the appropriate BSS 41 and delivered to MT 55 via a radio channel. Thus, the class of service is provided, at a minimum, across the carrier network, that is MTS 100 in which MT 55 has a subscription. Inter-network agreements may be arranged between multiple carriers to extend differentiated services outside of MTS 100.

As aforedescribed, GGSN 30 provides an interface between mobile telecommunications network 100 and public data network 60. Pursuant to providing multi-rate billing based on differentiated services, GGSN 30 may be provided with a filtering mechanism, e.g. software filters and/or hardware filters, that read the class of service marking, such as a traffic class octet of a packet passing therethrough, before forwarding the packet to the servicing SGSN. One or more call detail records may be maintained to accumulate traffic volume counts associated with a particular class of service.

The present invention enables the traffic volume counts in a traffic volume container of a call detail record to be limited to a single class of service thereby enabling multi-rate billing to be levied based on differentiated services. In a particular embodiment, one or more call detail records, referred to herein as a GGSN-call detail record (G-CDR), are established for MT 55 in GGSN 30 upon completion of a successful attach procedure with MTS 100.

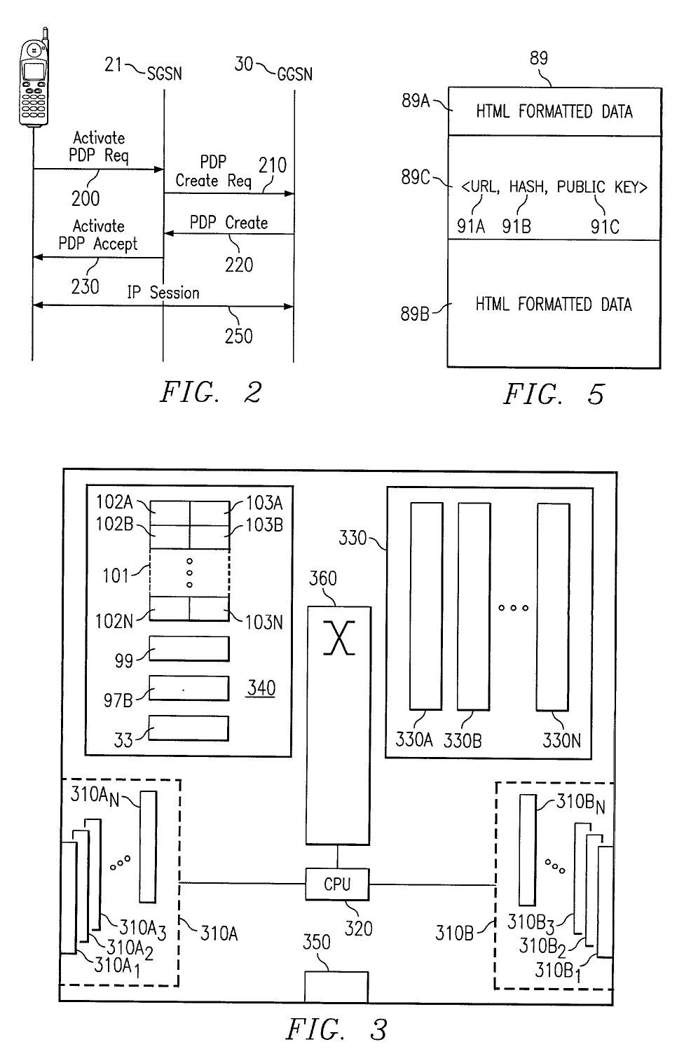

In FIG. 3, the is shown a simplified illustration of a network node that may be implemented as a GGSN 30, an access router, or another network node according to an embodiment of the invention. GGSN 30 may include one or more interface bays 310A and 310B each including one or more interface boards 310A₁-310A_{N} and 310B₁-310B_{N}, such as E1, T1, ATM, Ethernet or other network interface boards. A central processing unit 320, such as a SPARC microprocessor, a PowerPC microprocessor, and/or another central processing unit, may be included in GGSN 30 and may be coupled to interface bays 310A and 310B, a general processing bay 330 that may include one or more general processing boards 330A-330N, a memory bank 340, a power source 350 that may be coupled to any of the subsystems of GGSN 30, a switching system 360, and/or another core and/or GPRS support node subsystem. One or more general processing boards 330A-330N may be responsible for servicing core functions, such as execution of node management software, providing interfaces for various protocols for allowing communications with external nodes, execution of operation and maintenance applications and/or other core applications. Additionally, one or more general processing boards 330A-330N may support data application subsystems, such as context control subsystems that manage individual data sessions, a visitor register subsystem that incorporates VLR functionality into a GPRS support node, a network access subsystem, and/or other subsystems that facilitate access and provisioning of data communications with mobile devices.

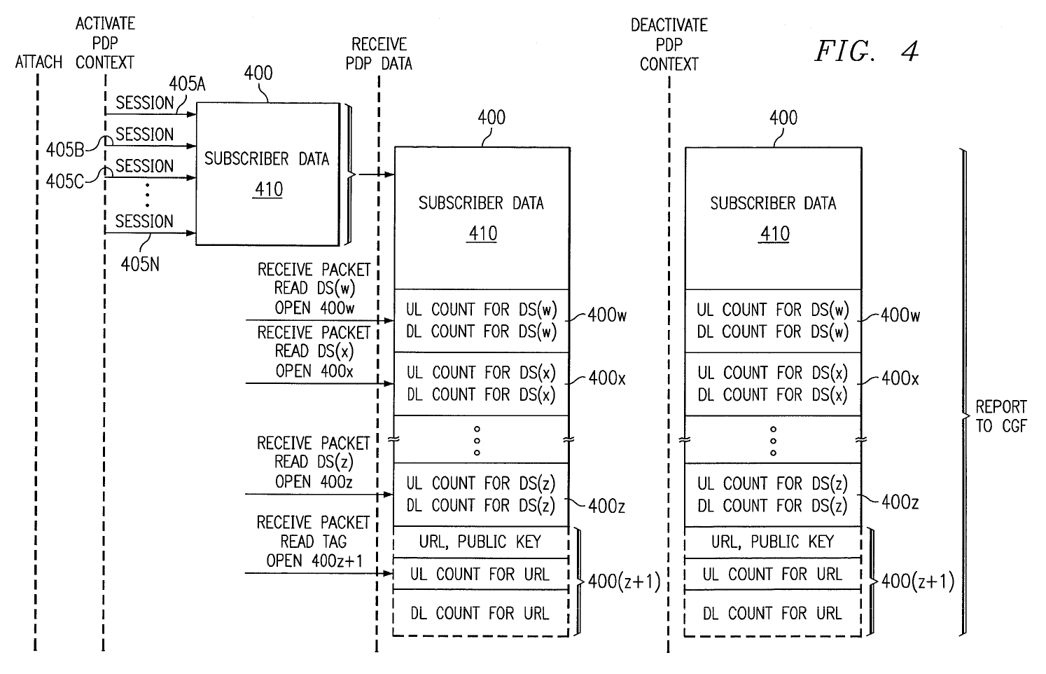

GGSN 30 determines a destination MT 55 upon address resolution of a received packet. Thus, by filtering a received packet for a differentiated services marking, a G-CDR may have traffic volume containers therein incremented according to the traffic volume and differentiated service thereby allowing for multi-rate billing based on differentiated services according to an embodiment of the invention. With reference to FIG. 4, there is shown an illustrative representation of a G-CDR 400 that provides distinct traffic volume accounting on a per-differentiated service basis and thus allows multi-rate billing according to an embodiment of the invention. G-CDR 400 typically includes a subscriber information component 410 including, for example, the international mobile subscriber identity (IMSI) or other identifying information. One or more G-CDRs may be generated by GGSN 30 by invocation of an accounting algorithm 99 executable by CPU 320. Accounting algorithm 99 may perform counts of traffic volumes associated with one or more data sessions and/or may make measurements of metrics of a data session between an originator, such as server 87, and a terminating device, such as MT 55. Additionally, G-CDR 400 may include one or more traffic volume containers 400W-400(Z+1) responsible for counting uplink and downlink traffic volume from and to MT 55. This data can then be used to impose usage tariffs on the subscriber account. Other data, for example a requested/negotiated quality of service indicator and timestamp information, may be included within each traffic volume container 400W-400(Z+1) as well.

MT 55 first performs an attach procedure with MTS 100 according to the general aforedescribed procedure. After completion of a successful attach procedure, MT 55 may then perform a PDP activation after which G-CDR 400 is opened in GGSN 30 currently servicing MT 55. Upon completion of a PDP context activation, PDP data to and/or from MT 55 may then be received by GGSN 30. Each PDP packet received by GGSN 30 is analyzed and the originating and/or destination MT 55 is resolved therefrom, e.g. from a source or destination address field of a received IP packet. A differentiated service marking, such as a class of service octet of an IPv6 packet header, is then read by GGSN 30. In the present example, numerous PDP data sessions 405A-405N are established. As each PDP packet is received and analyzed for the differentiated service thereof by GGSN 30, a counter is incremented to monitor the volume of data passed to and/or from MT 55 according to a particular differentiated service. For example, after a PDP data session 405A is activated and a packet is received at GGSN 30, a determination of the differentiated service_{(w)} is evaluated by GGSN 30. A counter 400W is then opened in G-CDR 400 and a count indicative of the volume of the received PDP packet is then recorded therein. Preferably, counter 400W includes both an uplink (UL) counter and a downlink (DL) counter to respectively record the volume of data transmitted from and to MT 55. Any additional PDP packets received by GGSN 30 and determined to have an identical differentiated service marking, such as a differentiated service codepoint, results in counter 400W being incremented accordingly.

In the illustrative example, numerous PDP data sessions 405A-405N are activated. Each data session 405A-405N may have a different or common differentiated service (DS) requested therefor. As GGSN 30 receives a PDP packet having a differentiated service for which a counter has not been opened, a new counter is accordingly opened therefor. For example, after activating PDP data session 405B, a packet may be received by GGSN 30 having a differentiated service(X). Upon reception of a first packet determined to have a differentiated service(X), a counter 400X is opened in G-CDR 400 for counting volumes of traffic to and/or from MT 55 for the particular differentiated service(X). As additional data sessions 405C-405N are established, additional packets may be received by GGSN 30 for which traffic volume containers are not established therefor. Each packet received by GGSN 30 and determined to have a service marking not having a traffic volume container established in G-CDR 400 therefor results in opening a new traffic volume container and accumulating a count of the packet/s having the newly encountered differentiated service therein in addition to counting data volumes of any packet/s received thereafter having the same differentiated service. In the present example, packets having five differentiated services DS_{(W)}-DS_{(Z+1)} are received by GGSN 30 and, accordingly, five traffic volume containers 400W-400Z+1 are opened to accumulate traffic volume counts made according to each encountered differentiated service.

In addition to providing multi-rate billing dependent on differentiated services, another embodiment of the invention allows multi-rate billing dependent on the source of data traffic. With the variation and proliferation of data services that have and are expected to penetrate the wireless telecommunications market, it would be advantageous to allow distinguishments to be made in call detail records, such as G-CDR 400, based on the source of the data delivered to MT 55.

With reference again to FIG. 1, there is shown a server 87 that may be maintained by a wireless content provider. Server 87 interfaces with data network 60 via an access router 80. MT 55 may make a request for content, such as an HTML document 89 that may be maintained within a database 88, to be delivered from server 87 by establishing a communication session, such as an HTTP communication session, therewith. Preferably, server 87 maintains an instance of a hashing algorithm 97A that may be executed to generate a hash of the URL of server 87. The hash may be encrypted, or ‘signed’, by a private key assigned to server 87 obtained from a certificate authority. The encrypted hash may later be utilized by an MTS 100 entity, such as GGSN 30, to authenticate data originated by server 87 in a manner that facilitates transaction-based billing according to an embodiment of the invention.

In FIG. 5, there is shown a simplified illustration of a file, such as HTML document 89, that may be utilized by MTS 100 of the present invention to provide transaction-based billing on a per-provider basis. HTML document 89 may include various HTML formatted data 89A and 89B. Embedded within HTML formatted data 89A-89B is a tag 89C. Tag 89C preferably includes a uniform resource locator (URL) 91A that specifies the location, that is the address, of HTML document 89, a signed hash 91B generated from URL 91A of server 87 by hashing algorithm 97A, and a public key 91C assigned to server 87.

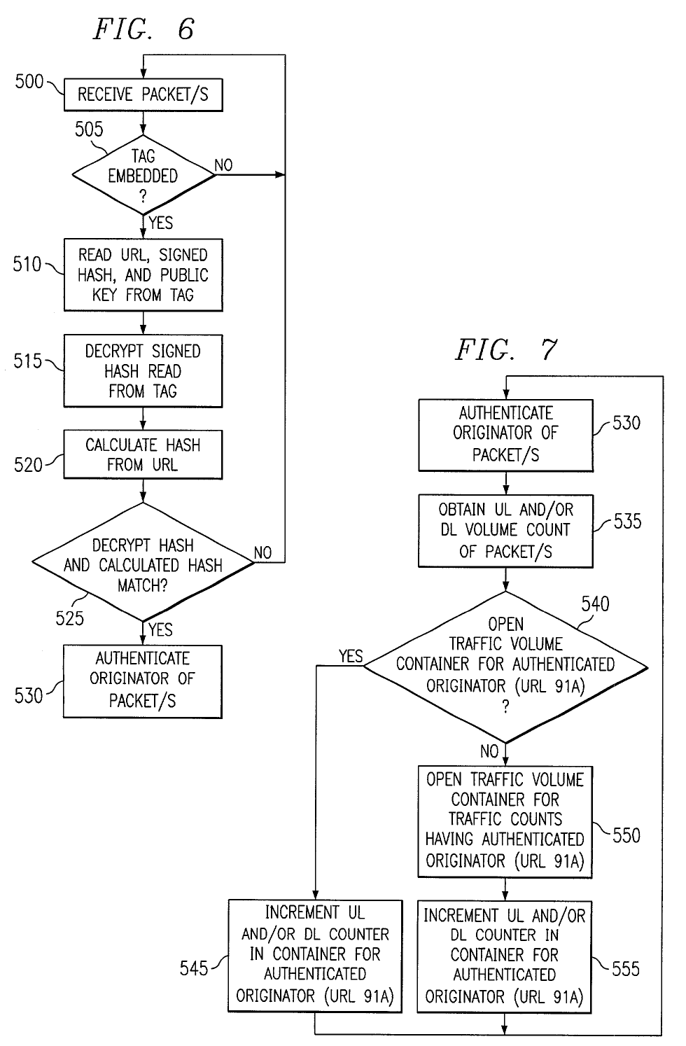

With reference to FIG. 6, there is shown a flowchart of an originator authentication technique according to an embodiment of the present invention. A node, such as GGSN 30, may invoke a filter 33, such as an authentication algorithm maintained in memory module 340 and executable by CPU 320 or a hardware based filter, upon reception of packet/s (step 500) thereby. Filter 33 may evaluate one or more packets for the presence of embedded tag 89C therein (step 505). GGSN 30 reads the contents of embedded tag 89C (step 510) upon determination of the presence of embedded tag 89C within the read packet/s. Alternatively, the originator authentication process returns to await reception of additional packet/s upon failure of identification of an embedded tag.

GGSN 30 decrypts signed hash 91B (step 510) using public key 91C provided in embedded tag 89C. Additionally, GGSN 30 calculates a hash (step 520) from URL 91A read from tag 89C using an instance of hashing algorithm 97B. A comparison is then made between the decrypted hash and the calculated hash (step 625) and authentication of the originator thereof is determined upon confirmation of a match therebetween (step 530). Failure to identify a match between the decrypted hash and the calculated hash results in originator authentication returning to await reception of additional packet/s.

Upon confirmation of the originator of document 89, GGSN 30 may provide differentiated accounting mechanisms for the context from which HTML document 89 was delivered according to an embodiment of the present invention. Preferably, the delivery of HTML document 89, and subsequent delivery of any additional data delivered in the same context, may be separately accounted for by opening an additional traffic volume container 400(Z+1) in G-CDR 400 and accumulating data volume counts therein that are restricted to the context and originator authenticated via recognition and analysis of embedded tag 89C. Container 400(Z+1) preferably maintains an identifier of the content provider, such as URL 91A and public key 91C obtained from embedded tag 89C, to provide distinct processing of the traffic volume counts accumulated therein. For example, upon reporting of G-CDR 400 to CGF 95, or another accounting node, the uplink and downlink counts accumulated in container 400(Z+1) may be partitioned from other traffic volume counts accumulated in G-CDR 400 and may be tariffed and levied distinctly therefrom.

GGSN 30 may maintain a database 101 that includes one or more records 102A-102N each respectively including an identifier, such as a uniform resource locator assigned to a particular originator. Each record 102A-102N may have one or more associated records 103A-103N that may respectively include a traffic treatment specification, such as a differentiated service codepoint, that may be written into the packet in which the embedded tag is included. For example, a differentiated services codepoint read from a record 103A-103N indexed by a respective record 102A-102N may be written into a traffic class octet of the packet in the event the packet is an Internet protocol version six packet or the differentiated services codepoint may be written into the type-of-service field of the packet in the event the packet is an Internet protocol version four packet. GGSN 30 will then forward the packet across network 100 and the packet will be routed throughout network 100 according to per-hop behaviors established for the differentiated services codepoint.

Provisioning of per-originator multi-rate billing may better be understood with reference to the flowchart of FIG. 7. Upon originator authentication of a packet/s, an uplink and/or downlink count of the packet may be obtained by GGSN 30 (step 535). G-CDR 400 maintained in a call detail record table 450 is then interrogated and an evaluation is made to determine if a traffic volume container therein has been allocated for dedicated traffic volume counts for a data session terminated by MT 55 and the content originator identified by URL 91A (step 540). Confirmation that a traffic volume container dedicated to traffic volume counts generated from a data session terminated by MT 55 and the originator identified by URL 91A results in an increment to an uplink and/or a downlink counter in the traffic volume container dedicated to URL 91A (step 545). Failure to identify an open traffic volume container dedicated to traffic volume counts generated from a data session terminated by MT 55 and the originator identified by URL 91A results in opening of a new traffic volume container in G-CDR 400 (step 550) and a subsequent increment to an uplink and/or downlink counter therein (step 555).

G-CDR 400 may periodically be reported to an accounting facility, such as a charging gateway function 95, that may be implemented as a personal computer including a system bus or busses to which various components may be coupled and by which communication between the various components is had. A microprocessor within CGF 95 may be connected to a system bus and supported by one or more read only memories and/or random access memories coupled thereto via the system bus. The microprocessor may be implemented as one of the Intel family of microprocessors including the 8088, 286, 386 or 486, and/or Pentium microprocessors. However, other microprocessors including, such as one or more of Motorola 68000, 68020 or the 68030 microprocessors and various Reduced Instruction Set Computer (RISC) microprocessors manufactured by IBM, Hewlett Packard, Sun, Intel, Motorola and others may be used in CGF 95. CGF may maintain a billing algorithm, for example in a random access memory, that is executable by a processor thereof and that is operable to extract contents of a call detail record and calculate tariffs to be levied against one or more entities, such as a mobile terminal subscriber and/or an originator of data traffic such as an operator of server 87. Traffic volume counts may obtained by CGF 95 and levies may accordingly be applied to MT 55 subscriber account. Levies applied to a subscriber account in response to traffic volume counts accumulated in G-CDR 400 may advantageously be applied on a per-provider basis. For example, traffic volume counts identified as originating from a particular source, such as a source identified by URL 91A, may have tariffs applied thereto at a discounted rate. Alternatively, levies applied to traffic volume counts identified as originating from a particular source may be charged to a content provider rather than to the subscriber account of MT 55. Call detail records having multiple traffic volume containers may have contents thereof parsed and levies independently calculated for one or more of the traffic volume counts. For example, a traffic volume count included within a call detail record and having an identifier of an originator associated therewith may have a tariff calculated therefor that is levied against the originator rather than the terminating device.

Thus, the present invention provides the ability to distinguish traffic volume counts of a call detail record on a per-differentiated service and a per-provider basis. Public key infrastructure techniques are utilized to authenticate a source of data traffic and, in conjunction with the multi-rate billing per differentiated service classifications as taught herein, transactional billing dependent on data transaction source is provided.

Although one or more embodiments of the method and apparatus of the present invention has been illustrated in the accompanying drawings and described above, it will be understood that the invention is not limited to the embodiments disclosed, but is capable of numerous rearrangements, modifications and substitutions without departing from the spirit of the invention as set forth and defined by the following claims.

What is claimed is:

1. A method of authenticating an originator of a packet in a network, comprising:
filtering the packet for a tag embedded therein;
reading the tag contents including an identifier and an encrypted hash;
decrypting the encrypted hash included in the tag;
calculating a second hash from the identifier of the originator; and
authenticating the originator of the packet upon determining the decrypted hash and the calculated hash are identical.

2. The method according to claim 1, wherein reading the tag contents including an identifier further comprises reading the tag contents including a uniform resource locator.

3. The method according to claim 1, wherein decrypting the encrypted hash included in the tag further comprises decrypting the encrypted hash with a public key assigned to the originator.

4. The method according to claim 1, wherein calculating a second hash from the identifier of the originator further comprises calculating the second hash from an instance of a hashing algorithm used by the originator to generate the encrypted hash.

5. The method according to claim 1, further comprising specifying a billing treatment for the packet upon authentication of the originator.

6. The method according to claim 5, wherein specifying a billing treatment for the packet further comprises writing a differentiated services codepoint into the packet upon authentication of the originator.

7. The method according to claim 6, wherein writing a differentiated services codepoint into the packet further comprises writing a differentiated services codepoint into at least one of a traffic class octet of an Internet protocol version six packet and a type-of-service field of an Internet protocol version four packet.

8. The method according to claim 5, wherein specifying a billing treatment for the packet upon authentication of the originator further comprises interrogating a database of billing treatment directives, the database including a record containing the identifier of the originator and an associated record specifying the billing treatment.

9. The method according to claim 8, wherein interrogating a database of billing treatment directives further comprises interrogating the database that includes a record containing a uniform resource locator of the originator and the associated record contains a differentiated service code point.

10. The method according to claim 9, wherein interrogating the database further comprises:
supplying the database with the identifier read from the tag contents, the identifier indexing the record containing the uniform resource locator; and
reading the differentiated service code point from the associated record.

11. The method according to claim 5, further comprising:
generating a call detail record having a traffic volume count of a data session that includes the packet; and
calculating a tariff for the data session based upon the contents of the call detail record.

12. The method according to claim 11, wherein calculating a tariff for the data session further comprises calculating the tariff and levying the tariff against the originator of the packet.

13. The method according to claim 11, wherein calculating a tariff for the data session further comprises parsing the traffic volume count from other traffic volume counts included in the call detail record, the calculated tariff calculated for the parsed traffic volume count independently of the other traffic volume counts.

14. The method according to claim 11, wherein generating a call detail record having a traffic volume count further comprises generating a call detail record having the traffic volume count and the identifier associated therewith.

15. A node in a network for authenticating an originator of a packet, comprising:
a processing unit;
a memory unit operable to store an authentication algorithm therein that is executable by the processing unit; and
an interface to a network medium operable to receive the packet, the authentication algorithm operable to filter the packet for a tag embedded therein, decrypt an encrypted hash in the embedded tag, calculate a hash from an identifier in the tag, and authenticate the originator upon a comparison between the decrypted hash and the calculated hash.

16. The node according to claim 15, further comprising an instance of a hashing algorithm executable by the processing unit, a second instance of the hashing algorithm executable by the originator of the packet and operable to generate the encrypted hash.

17. The node according to claim 15, further comprising an accounting algorithm executable by the processing unit and operable to generate a call detail record including a traffic volume count of a data session including the packet.

18. The node according to claim 17, wherein the call detail record further includes the identifier in association with the traffic volume count.

19. The node according to claim 15, wherein the identifier is a uniform resource locator of the originator.

20. The node according to claim 15, further comprising a database having a record maintaining an identification of the originator and an associated record having a traffic treatment specification, the node operable to condition the packet such that the network forwards the packet according to parameters associated with the traffic treatment specification.

21. The node according to claim 20, wherein the traffic treatment specification is a differentiated services codepoint.

22. The node according to claim 21, wherein the node is operable to write the differentiated services codepoint into at least one of a traffic class octet of an Internet protocol version six packet and a type-of-service field of an Internet protocol version four packet.

23. The node according to claim 17, wherein the node is operable to forward the call detail record to a second node in the network operable to perform billing procedures on the contents thereof.

24. A telecommunication network operable to transmit a data packet from an originator to a terminating device within the network, the network comprising:
a first node connected to a data network and operable to receive the packet generated by the originator, the first node operable to execute an authentication algorithm operable to filter the packet for a tag embedded therein, decrypt an encrypted hash in the embedded tag, calculate a hash from an identifier in the tag, and authenticate the originator upon a comparison between the decrypted hash and the calculated hash; and
a second node operable to receive the packet from the first node and transmit the packet to a terminating device.

25. The network according to claim 24, wherein the terminating device is a mobile terminal.

26. The network according to claim 25, wherein the network is a mobile telecommunication system and the second node is a switching system, the network further comprising:
a base station subsystem; and
a base transceiver station managed by the base station subsystem, the terminating device in communication with the base transceiver station.

27. The network according to claim 26, wherein the first node is a gateway general packet radio services support node.

28. The network according to claim 24, wherein the originator is operable to execute a first instance of a hashing algorithm that generates the encrypted hash, the first node further comprising a second instance of the hashing algorithm operable to calculate the hash from the identifier in the tag.

29. The network according to claim 24, further comprising an accounting algorithm executable thereby and operable to generate a call detail record including a traffic volume count of a data session including the packet.

30. The network according to claim 29, wherein the call detail record further includes the identifier in association with the traffic volume count.

31. The network according to claim 30, wherein the identifier is a uniform resource locator of the originator.

32. The network according to claim 31, further comprising a database having a record maintaining an identification of the originator and an associated record having a traffic treatment specification, the first node operable to condition the packet such that the network forwards the packet according to parameters associated with the traffic treatment specification

33. The network according to claim 32, wherein the traffic treatment specification is a differentiated services codepoint.

34. The network according to claim 33, wherein the first node is operable to write the differentiated services codepoint into at least one of a traffic class octet of an Internet protocol version six packet and a type-of-service field of an Internet protocol version four packet

35. The network according to claim 34, wherein the first node and the second node are operable to provide forwarding treatments of the packet across the network according to service specifications associated with the differentiated services codepoint.

36. The network according to claim 24, further comprising a billing node operable to perform billing procedures on a call detail record, the billing node including an interface with the first node and operable to receive a call detail record thereon, the billing node operable to execute a billing algorithm operable to generate a tariff dependent on contents of a traffic volume container included in the call detail record, the call detail record having the identifier of the originator associated therewith, the tariff further dependent on the identifier.

37. The network according to claim 36, wherein the tariff is levied against the originator.

38. The network according to claim 36, wherein the tariff is levied against the terminating device.

39. The network according to claim 36, wherein the call detail record includes other traffic volume containers, the tariff dependent on the identifier being independent of the other traffic volume containers.
